(19) United States
(12) Patent Application Publication
(10) Pub. No.: US 2026/0204981 A1
(43) Pub. Date: Jul. 16, 2026

(54) Handicraft With Rotating Structure

(71) Applicant: Huizhou Victory Technology Ltd, Huizhou City (CN)

(72) Inventor: Hesheng Liu, Huaihua City (CN)

(73) Assignee: Huizhou Victory Technology Ltd, Huizhou City (CN)

(21) Appl. No.: 19/090,944

(22) Filed: Mar. 26, 2025

(30) Foreign Application Priority Data
Jan. 14, 2025 (CN) 202510052482.3

(51) Int. Cl. H02K 7/14; H02K 5/10; H02K 7/00; H02K 11/00

(52) U.S. Cl. CPC H02K 7/14; H02K 5/10; H02K 7/003; H02K 11/0094

(57) ABSTRACT

A handicraft with a rotating structure is provided, which includes a decorative piece for decorative purposes, a rotating component configured to provide rotational power, and a seat component. A power supply component configured to provide electricity is provided on the seat component, and the decorative piece is provided on the seat component. The decorative piece and the rotating component are connected and rotated by the power provided by the rotating component. The design of the present disclosure provides power to the rotating component through the power supply component, and the rotating component starts to rotate, thereby driving the decorative piece to start rotating, and adding entertainment to the product.

### CROSS-REFERENCE TO RELATED APPLICATIONS

This application claims priority to Chinese Patent Application No. 202510052482.3, filed on January 14, 2025, which is hereby incorporated by reference in its entirety.

### TECHNICAL FIELD

The present disclosure relates to the field of handicrafts technologies, and in particular, to a handicraft with a rotating structure.

### BACKGROUND

Handicrafts refer to goods with certain artistic attributes that can meet the daily needs of the people and have decorative and functional uses. Handicrafts originate from people's lives, but they also create value beyond life. They are the crystallization of human wisdom and modern industrial technology. With the development of the times, decorative crafts have become indispensable decorative crafts in various themed activities and festivals. Different themed crafts are available for different festivals and events. Nowadays, people's demand for diversity in handicrafts is also increasing.

However, existing decorative crafts have lighting or water drawing functions. In order to increase the diversity and fun of the crafts, some decorative objects will be set on the crafts. However, the current decorative objects can only be stationary, have a single function, and lack ornamental value, rendering it difficult to meet the current market's demand for diversity and entertainment in decorative crafts. Therefore, it is necessary to develop an updated structural design that not only has ornamental value, but also displays its unique charm through rotation to solve the above problems.

### SUMMARY

The purpose of the present disclosure is to provide a handicraft with a rotating structure to solve the problems of single product function and difficulty in meeting the diverse and entertaining needs of the existing market for decorative wind lights in the background technology.

The present disclosure provides the following technical solution: a handicraft with a rotating structure, including a decorative piece, a rotating component configured to provide rotational power, and a seat component; a power supply component configured to provide electricity is provided on the seat component, and the decorative piece is provided on the seat component; the decorative piece and the rotating component are connected and rotated by the power provided by the rotating component.

In some embodiments of the present disclosure, a sealing component is provided on the seat component, the sealing component is provided between the decorative piece and the seat component, the sealing component and the seat component are fixedly connected or integrally formed.

In some embodiments of the present disclosure, the rotating component includes a rotating structure, an eccentric component, and a rotating motor component; one end of the rotating structure is connected to the decorative piece, the other end of the rotating structure is connected to the eccentric component, the eccentric component is connected to the rotating motor component, and the rotating structure is rotated through the eccentric component and the rotating motor component.

In some embodiments of the present disclosure, the rotating structure includes a rotating shaft and a toggle piece, the rotating shaft and the toggle piece are fixedly connected or integrally formed; one end of the rotating shaft is connected to the decorative piece, the other end of the rotating shaft is connected to the eccentric component, and the toggle piece is connected to the eccentric component.

In some embodiments of the present disclosure, the eccentric component includes an eccentric wheel and a support element, an upper end of the eccentric wheel is connected to the toggle piece, a lower end of the eccentric wheel is connected to the rotating motor component, an upper end of the support element is connected to the rotating shaft, and two lower ends of the support element are respectively connected to the rotating shaft and the rotating motor component.

In some embodiments of the present disclosure, a slot hole is provided on the toggle piece, a column is provided on the eccentric wheel, the slot hole matches the column, and the toggle piece is connected to the eccentric wheel through the slot hole and the column.

In some embodiments of the present disclosure, the rotating motor component includes a rotating motor, a motor shaft, and a protective shell; one end of the motor shaft is connected to the rotating motor, the other end of the motor shaft is connected to the eccentric wheel; the rotating motor is provided inside the protective shell, and the protective shell and the support element are fixedly connected.

In some embodiments of the present disclosure, the rotating motor is a brushed motor or a brushless motor.

In some embodiments of the present disclosure, the sealing component includes a container body and a container seat; the container body and the container seat form a sealed cavity, and the sealed cavity formed by the container body and the container seat is filled with liquid.

In some embodiments of the present disclosure, a stirring structure is provided at a bottom of the container seat, and the stirring structure is provided with a stirring component and a stirring motor component; the stirring component is provided on the stirring motor component, and the stirring component achieves stirring of the liquid through the stirring motor component.

In some embodiments of the present disclosure, the stirring motor component is a brushless motor or a brushed motor.

In some embodiments of the present disclosure, the stirring motor component includes a rotating magnet, a stator, a support frame, and a stirring shaft; the rotating magnet is provided on the support frame and inside the container seat, the stirring shaft is provided on the support frame, the stator is provided in the support frame and provided outside the container seat.

In some embodiments of the present disclosure, the container seat and the support frame are fixedly connected or integrally formed.

In some embodiments of the present disclosure, the stirring component is a stirring impeller, and the stirring impeller is provided on the rotating magnet through the stirring shaft.

In some embodiments of the present disclosure, the container body and the container seat are clamping connected or rotatably connected.

In some embodiments of the present disclosure, the seat component includes a base, the power supply component includes a battery box and a battery cover; the base and the battery box are fixedly connected or integrally formed, and the battery box and the battery cover are fixedly connected.

In some embodiments of the present disclosure, the battery box is provided with a battery groove configured to install batteries and a control circuit board configured to control the rotating motor component and the stirring motor component.

In some embodiments of the present disclosure, the base and the battery box are clamping connected or rotatably connected.

In some embodiments of the present disclosure, the liquid is a mixture of one or more combinations of water, oil, or liquid pigments.

1. The handicraft with a rotating structure of the present disclosure includes a decorative piece for decorative purposes, a rotating component for providing rotational power, and a seat component. The decorative piece is provided on the seat component, connected to the rotating component, and rotated by the power provided by the rotating component. By providing power to the rotating component through the power supply component, the rotating component begins to rotate, thereby driving the decorative piece to rotate, and adding entertainment to the product and effectively solving the problems of single functionality, lack of ornamental value, and difficulty in meeting the current market's demand for diversity and entertainment in decorative crafts.

2. The handicraft with a rotating structure of the present disclosure includes a rotating structure, an eccentric component, and a rotating motor component. One end of the rotating structure is connected to the decorative piece, and the other end of the rotating structure is connected to the eccentric component. The eccentric component is connected to the rotating motor component, and the rotating structure is rotated through the eccentric component and the rotating motor component. The rotating structure includes a rotating shaft and a toggle piece. The toggle piece is provided with a slot hole, and the eccentric component includes an eccentric wheel and a support element. The eccentric wheel is provided with a column, and the toggle piece is connected to the eccentric wheel through the slot hole and the column. Through this design, after the rotating motor starts to rotate, the eccentric wheel is driven to rotate by the rotating shaft on the motor. The column on the eccentric wheel passes through the slot hole on the toggle piece, and through a mutual cooperation between the eccentric wheel and the toggle piece, the toggle piece can reciprocate left and right up and down or rotate in a circular motion within a certain angle, thereby driving the decorative piece to swing left and right up and down or rotate in a circular motion, and adding entertainment to the product.

3. The handicraft with a rotating structure of the present disclosure is provided with a stirring structure inside the container seat. The stirring structure is provided with a stirring component and a stirring motor component. The stirring component is provided on the stirring motor component, and the stirring component achieves stirring of the liquid through the stirring motor component. By providing the stirring structure, the liquid inside the product can be stirred to achieve a more aesthetically pleasing effect. The stirring component is not easily detached, and the stirring effect is stable.

4. The handicraft with a rotating structure of the present disclosure includes a stirring motor component including a rotating magnet, a stator, a support frame, and a rotating shaft. The rotating magnet is provided on the support frame and inside the container seat, the rotating shaft is provided on the support frame, the stator is provided inside the support frame, and provided outside the container seat. Through this design, the rotating magnet and stator of the motor component are respectively provided inside and outside the container seat. On the one hand, it makes the installation of the stator simpler and more convenient. On the other hand, when the stator is damaged, it only needs to be replaced without replacing the entire motor component, effectively reducing production costs.

### BRIEF DESCRIPTION OF DRAWINGS

In order to provide a clearer explanation of the embodiments or technical solutions in the present application or existing technology, a brief introduction will be given to the accompanying drawings required for the embodiments or existing technology description. It is obvious that the accompanying drawings described below are only some embodiments of the present application. For those skilled in the art, other drawings can be obtained based on these drawings without requiring creative work.

FIG. 1 is a semi-sectional schematic diagram of a handicraft with a rotating structure according to the present disclosure.

FIG. 2 is an exploded schematic diagram of the handicraft with a rotating structure according to the present disclosure.

FIG. 3 is an exploded schematic diagram of a rotating structure of the handicraft with a rotating structure according to the present disclosure.

FIG. 4 is an exploded schematic diagram of an eccentric component of the handicraft with a rotating structure according to the present disclosure.

FIG. 5 is an exploded schematic diagram of a rotating motor component of the handicraft with a rotating structure according to the present disclosure.

FIG. 6 is a semi-sectional schematic diagram of a stirring structure of the handicraft with a rotating structure of the present disclosure.

FIG. 7 is a three-dimensional schematic diagram of a power supply component of the handicraft with a rotating structure according to the present disclosure.

Numeral reference: 1-decorative piece; 2-rotating component; 21-rotating structure; 211-rotating shaft; 212-toggle piece; 2121-slot hole; 22-eccentric component; 221-eccentric wheel; 2212-column, 222-support element; 23-rotating motor component; 231-rotating motor; 232-motor shaft; 3-seat component; 31-base; 4-sealing component; 41-container body; 42- container seat; 5-stirring structure; 51-stirring component; 511-stirring impeller; 52-stirring motor component; 521-rotating magnet; 522-stator, 523-support frame; 524-stirring shaft; 6- power supply component; 61-battery box; 611-battery groove, 612-control circuit board; 62- battery cover.

### DESCRIPTION OF EMBODIMENTS

The following provides a detailed description of the embodiments of the present application, examples of which are shown in the accompanying drawings, where the same or similar reference numerals from beginning to end represent the same or similar elements or components with the same or similar functions. The embodiments described below with reference to the accompanying drawings are exemplary and are only used to explain the present application, and should not be construed as limiting the present application.

In the description of this application, it should be understood that the terms "first" and "second" are only used for descriptive purposes and cannot be understood as indicating or implying relative importance or implying the number of technical features indicated. Thus, the features limited to "first" and "second" may explicitly or implicitly include one or more of the aforementioned features. In the description of this application, the meaning of "multiple" refers to two or more, unless otherwise specifically limited.

In the description of this application, it should be noted that unless otherwise specified and limited, terms "installation" and "connection" should be broadly understood, for example, they can be fixed connections, detachable connections, or integrated connections; it can be a mechanical connection, an electrical connection, or communication with each other; it can be directly connected or indirectly connected through an intermediate medium, and it can be a connection within two components or an interaction relationship between two components. For those skilled in the art, specific meanings of the above terms in this application can be understood according to a specific situation.

In the description of this application, it should be understood that terms "up", "down", "side", "front", "back", etc. indicate orientation or position relationships based on installation, only for a convenience of describing this application and simplifying the description, and do not indicate or imply that the device or component referred to must have a specific orientation, be constructed and operated in a specific orientation, and therefore cannot be understood as a limitation of this application.

In the description of this application, it should be noted that term "and/or" is only a description of the association relationship between related objects, indicating that there can be three types of relationships, such as A and/or B, which can represent: the existence of A alone, the existence of A and B at the same time, and the existence of B alone.

It should be noted that in the embodiments of the present application, the same reference numerals are used to represent the same components or parts. For the same parts in the embodiments of the present application, only one part or component may be marked with a reference numeral in the figures. It should be understood that for other identical parts or components, the reference numerals are also applicable.

Besides that, in this application, the technical features described in an open manner include both closed technical solutions composed of the listed features and open technical solutions containing the listed features.

In order to further understand the disclosure, characteristics, and efficacy of the present application, the following embodiments are listed and explained in detail with the accompanying drawings:

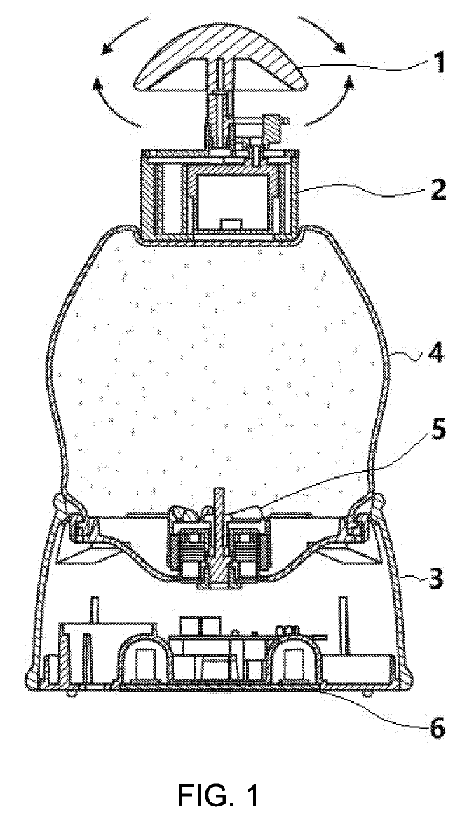

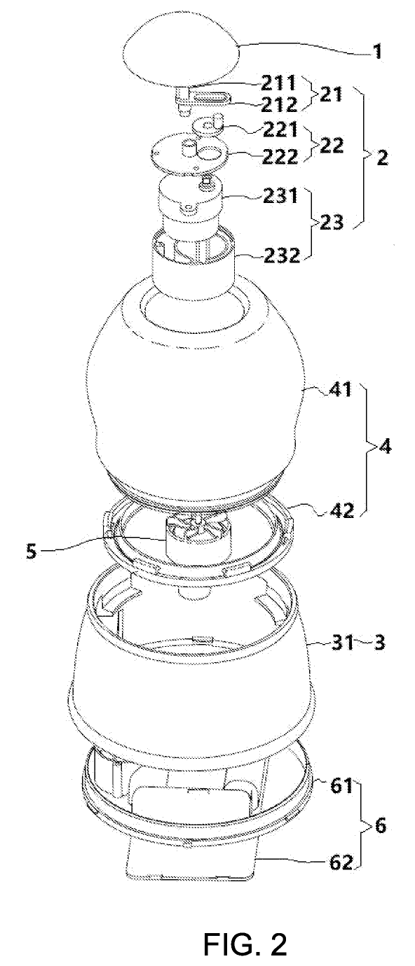

As shown in FIGS. 1-5, a handicraft with a rotating structure includes a decorative piece 1 for decorative purposes, a rotating component 2 configured to provide rotational power, and a seat component 3. A power supply component 6 configured to provide electricity is provided on the seat component 3, and the decorative piece 1 is provided on the seat component 3. The decorative piece 1 is connected to the rotating component 2 and is rotated by power provided by the rotating component 2. In this embodiment, power is provided to the rotating component through the power supply component, and the rotating component starts to rotate, thereby driving the decorative piece to start rotating, adding entertainment to the product and effectively solving problems of single function, lack of ornamental value, and difficulty in meeting the existing market's demand for diversity and entertainment of decorative wind lights. Of course, the above structural design is not limited to this and can also be other structural designs that serve the same purpose.

In an implementation mode, a sealing component 4 is provided on the seat component 3, and the sealing component 4 is provided between the decorative piece 1 and the seat component 3. The sealing component 4 is fixedly connected or integrally formed with the seat component 3. In this embodiment, the sealing component and the seat component are fixedly connected, rendering the installation of the sealing component more convenient through this structure. Of course, the above structural design is not limited to this and can also be other structural designs that serve the same purpose.

In an implementation mode, the rotating component 2 includes a rotating structure 21, an eccentric component 22, and a rotating motor component 23. One end of the rotating structure 21 is connected to the decorative piece 1, and the other end of the rotating structure 21 is connected to the eccentric component 22. The eccentric component 22 is connected to the rotating motor component 23, and the rotating structure 21 is rotated through the eccentric component 22 and the rotating motor component 23. In this embodiment, the rotating structure is rotated through the eccentric component and the rotating motor component, thereby driving the decorative piece to rotate. Of course, the above structural design is not limited to this and can also be other structural designs that serve the same purpose.

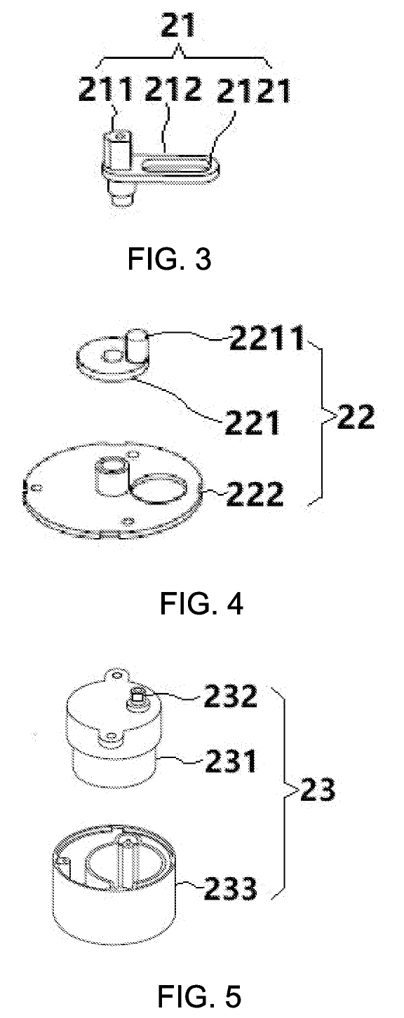

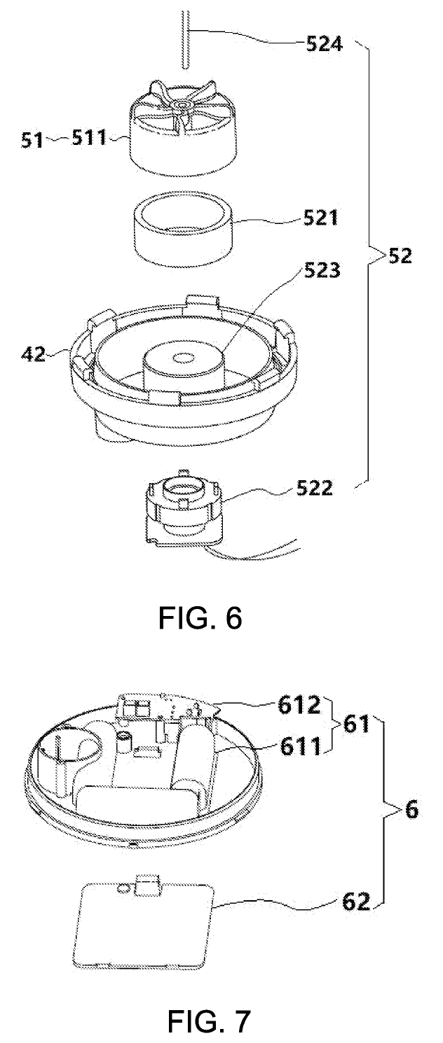

In an implementation mode, as shown in FIGS. 3 and 4, the rotating structure 21 includes a rotating shaft 211 and a toggle piece 212. The rotating shaft 211 and the toggle piece 212 are fixedly connected or integrally formed. One end of the rotating shaft 211 is connected to the decorative piece 1, the other end of the rotating shaft 211 is connected to the eccentric component 22, and the toggle piece 212 is connected to the eccentric component 22. The eccentric component 22 includes an eccentric wheel 221 and a support element 222. An upper end of the eccentric wheel 221 is connected to the toggle piece 212, a lower end of the eccentric wheel 221 is connected to the rotating motor component 23, the upper end of the support element 222 is connected to the rotating shaft 211, and two lower ends of the support element 222 are respectively connected to the rotating shaft 211 and the rotating motor component 23. A slot hole 2121 is provided on the toggle piece 212, and a column 2212 is provided on the eccentric wheel 221. The toggle piece 212 is connected to the eccentric wheel 221 through the slot hole 2121 and the column 2211. In this embodiment, a mutual cooperation between the column on the eccentric wheel and the slot hole on the toggle piece allows the rotating structure to oscillate back and forth, up and down, or rotate in a circular motion within a certain angle. Of course, the above structural design is not limited to this and can also be other structural designs that serve the same purpose.

In an implementation mode, as shown in FIG. 5, the rotating motor component 23 includes a rotating motor 231, a motor shaft 232, and a protective shell 233. One end of the motor shaft 232 is connected to the rotating motor 231, and the other end of the motor shaft 232 is connected to the eccentric wheel 221. The rotating motor 231 is provided in the protective shell 233, and the protective shell 233 is fixedly connected to the support element 222. In this embodiment, the rotating motor drives the motor shaft to rotate and to drive the eccentric wheel to rotate. By placing the rotating motor inside the protective shell, it is less likely to be damaged by external factors. Of course, the above structural design is not limited to this and can also be other structural designs that serve the same purpose.

In an implementation mode, the rotating motor 231 is a brushed motor or a brushless motor. In this embodiment, the rotating motor is the brushed motor. Of course, the type of rotating motor is not limited to this and can also be other motors that perform the same function.

In an implementation mode, the sealing component 4 includes a container body 41 and a container seat 42. The container body 41 and the container seat 42 form a sealed cavity, and the sealed cavity formed by the container body 41 and the container seat 42 is filled with liquid. In this embodiment, liquid is provided in the sealed cavity formed by the container body and the container seat, rendering the product more aesthetically pleasing. Of course, the above structural design is not limited to this and can also be other structural designs that serve the same purpose.

In an implementation mode, a stirring structure 5 is provided at a bottom of the container seat 42, and the stirring structure 5 is provided with a stirring component 51 and a stirring motor component 52. The stirring component 51 is provided on the stirring motor component 52, and the stirring component 51 achieves stirring of the liquid through the stirring motor component 52. In this embodiment, the stirring structure is configured to achieve the effect of stirring the liquid, rendering the product more aesthetically pleasing. Of course, the above structural design is not limited to this and can also be other structural designs that serve the same purpose.

In an implementation mode, the stirring motor component 52 is a brushless motor or a brushed motor. In this embodiment, the stirring motor component is the brushless motor. The stirring motor component 52 includes a rotating magnet 521, a stator 522, a support frame 523, and a stirring shaft 524. The rotating magnet 521 is provided on the support frame 523 and in the container seat 42, the stirring shaft 524 is provided on the support frame 523, and the stator 522 is provided in the support frame 523 and provided outside the container seat 42. In this embodiment, by separating the stirring motor component and providing it inside and outside the container seat, the stirring component is not easily detached, and when the stator is damaged, there is no need to replace the entire stirring motor component, only the stator needs to be replaced. Of course, the above structural design is not limited to this and can also be other structural designs that serve the same purpose. Of course, the type of rotating motor is not limited to this, and it can also be other motors with the same function, brushed motors, or conventional motors.

In an implementation mode, the container seat 42 and the support frame 523 are fixedly connected or integrally formed. In this embodiment, the container seat 42 and the support frame 523 are integrally formed. By using this structure, it becomes more stable. Of course, the above structural design is not limited to this and can also be other structural designs that serve the same purpose.

In an implementation mode, the stirring component 51 is a stirring impeller 511, which is provided on the rotating magnet 521 through the stirring shaft 524. In this embodiment, the stirring effect is better by providing the stirring impeller on the rotating magnet. Of course, the above structural design is not limited to this and can also be other structural designs that serve the same purpose.

In an implementation mode, the container body 41 and the container seat 42 are clamping connected or rotatably connected. In this embodiment, the container body and the container seat are clamping connected, which makes the assembly more convenient and effectively improves production efficiency. Of course, the connection method is not limited to this and can also be other connection methods that have the same effect.

In an implementation mode, the seat component 3 includes a base 31, and the power supply component 6 includes a battery box 61 and a battery cover 62. The base 31 and the battery box 61 are fixedly connected or integrally formed, and the battery box 61 and the battery cover 62 are fixedly connected. The battery box 61 is provided with a battery groove 611 configured to install batteries and a control circuit board 612 configured to control the rotating motor component 23 and the stirring motor component 52. In this embodiment, power is provided to the rotating motor component and the stirring motor component through a battery, and the control circuit board controls the start and stop of the rotating motor component and the stirring motor component. After the stirring motor component is powered on, it starts to drive the stirring component to achieve the effect of stirring the liquid. At the same time, after the rotating motor component is powered on, it drives the rotating structure and the eccentric component to start rotating, thereby achieving the effect of rotating the decorative piece. Of course, the above structural design is not limited to this and can also be other structural designs that serve the same purpose.

In an implementation mode, the liquid is water, oil, or liquid pigment. In this embodiment, the liquid is a mixture of one or two or more types of water, which can make the product more aesthetically pleasing. Of course, the type of liquid is not limited to this and can be other liquids that have the same effect.

Working principle: power is provided to the stirring motor and rotating motor component through the power supply component. The stirring motor component drives the stirring component to stir the liquid inside the sealing component, thereby achieving the stirring effect. At the same time, after the motor is powered on, it begins to rotate. The eccentric wheel is driven to rotate by the rotating shaft on the motor. The column on the eccentric wheel passes through the slot hole on the toggle piece, and through the mutual cooperation between the eccentric wheel and the toggle piece, the toggle piece can reciprocate left, right, up and down or rotate in a circular motion within a certain angle, thereby driving the decorative piece to swing left, right, up and down or rotate in a circular motion, and adding entertainment to the product.

The various technical features of the above embodiments can be combined in any way. In order to make the description concise, not all possible combinations of the various technical features in the above embodiments have been described. However, as long as there is no contradiction in the combination of these technical features, they should be considered within the scope of this specification.

The above embodiments only express several embodiments of the present disclosure, and their descriptions are more specific and detailed, but should not be understood as limiting the scope of the present application. It should be noted that for those skilled in the art, several modifications and improvements can be made without departing from the inventive concept, which are within the protection scope of the present disclosure. Therefore, the protection scope of the present disclosure should be based on the appended claims.

What is claimed is:

1. A handicraft with a rotating structure, comprising a decorative piece, a rotating component configured to provide rotational power, and a seat component;
a power supply component configured to provide electricity is provided on the seat component, and the decorative piece is provided on the seat component; the decorative piece and the rotating component are connected and rotated by the power provided by the rotating component.

2. The handicraft with a rotating structure according to claim 1, wherein a sealing
component is provided on the seat component, the sealing component is provided between the decorative piece and the seat component,the sealing component and the seat component are fixedly connected or integrally formed.

3. The handicraft with a rotating structure according to claim 2, wherein the rotating component comprises a rotating structure, an eccentric component, and a rotating motor
component;one end of the rotating structure is connected to the decorative piece, the other end of the rotating structure is connected to the eccentric component,the eccentric component is connected to the rotating motor component, and the rotating structure is rotated through the eccentric component and the rotating motor component.

4. The handicraft with a rotating structure according to claim 3, wherein the rotating structure comprises a rotating shaft and a toggle piece,
the rotating shaft and the toggle piece are fixedly connected or integrally formed;
one end of the rotating shaft is connected to the decorative piece, the other end of the rotating shaft is connected to the eccentric component, and the toggle piece is connected to the eccentric component.

5. The handicraft with a rotating structure according to claim 4, wherein the eccentric component comprises an eccentric wheel and a support element,
an upper end of the eccentric wheel is connected to the toggle piece, a lower end of the eccentric wheel is connected to the rotating motor component,
an upper end of the support element is connected to the rotating shaft, and two lower ends of the support element are respectively connected to the rotating shaft and the rotating motor component.

6. The handicraft with a rotating structure according to claim 5, wherein a slot hole is provided on the toggle piece, a column is provided on the eccentric wheel, the slot hole matches the column, and the toggle piece is connected to the eccentric wheel through the slot hole and the column.

7. The handicraft with a rotating structure according to claim 6, wherein the rotating motor component comprises a rotating motor, a motor shaft, and a protective shell,
one end of the motor shaft is connected to the rotating motor, the other end of the motor shaft is connected to the eccentric wheel,
the rotating motor is provided inside the protective shell, and the protective shell and the support element are fixedly connected.

8. The handicraft with a rotating structure according to claim 7, wherein the rotating motor is a brushed motor or a brushless motor.

9. The handicraft with a rotating structure according to claim 8, wherein the sealing component comprises a container body and a container seat, the container body and the
container seat form a sealed cavity, and the sealed cavity formed by the container body and the container seat is filled with liquid.

10. The handicraft with a rotating structure according to claim 9, wherein a stirring structure is provided at a bottom of the container seat, and the stirring structure is provided with a stirring component and a stirring motor component;
the stirring component is provided on the stirring motor component, and the stirring component achieves stirring of the liquid through the stirring motor component.

11. The handicraft with a rotating structure according to claim 10, wherein the stirring motor component is a brushless motor or a brushed motor.

12. The handicraft with a rotating structure according to claim 10, wherein the stirring
motor component comprises a rotating magnet, a stator, a support frame, and a stirring shaft;
the rotating magnet is provided on the support frame and inside the container seat,
the stirring shaft is provided on the support frame, the stator is provided in the support frame and provided outside the container seat.

13. The handicraft with a rotating structure according to claim 12, wherein the container
seat and the support frame are fixedly connected or integrally formed.

14. The handicraft with a rotating structure according to claim 13, wherein the stirring component is a stirring impeller, and the stirring impeller is provided on the rotating magnet through the stirring shaft.

15. The handicraft with a rotating structure according to claim 14, wherein the container
body and the container seat are clamping connected or rotatably connected.

16. The handicraft with a rotating structure according to claim 15, wherein the seat component comprises a base,
the power supply component comprises a battery box and a battery cover,
the base and the battery box are fixedly connected or integrally formed, and the battery
box and the battery cover are fixedly connected.

17. The handicraft with a rotating structure according to claim 16, wherein the battery box is provided with a battery groove configured to install batteries and a control circuit board configured to control the rotating motor component and the stirring motor component.

18. The handicraft with a rotating structure according to claim 16, wherein the base and
the battery box are clamping connected or rotatably connected.

19. The handicraft with a rotating structure according to claim 18, wherein the liquid is a mixture of one or more combinations of water, oil, or liquid pigments.
